(19) United States
(12) Patent Application Publication
(10) Pub. No.: US 2006/0281400 A1
(43) Pub. Date: Dec. 14, 2006

(54) Brodacast information receiving apparatus and broadcast information receiving and reproducing apparatus

(75) Inventor: Takatoshi Ueyama, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Osaka (JP)

(21) Appl. No.: 11/448,056

(22) Filed: Jun. 7, 2006

(30) Foreign Application Priority Data
Jun. 9, 2005 (JP) 2005-168937

(51) Int. Cl. H04H 1/00

(52) U.S. Cl. 455/3.01

(57) ABSTRACT

A broadcast information receiving apparatus capable of selecting and storing useful information for users. A screening signal generating unit generates a screening signal indicating a code of a section including a destination set by a user through a user operation unit. A data screening unit compares a section code included in regional information received by the receiving unit with the screening signal, and compares an ID code included in the regional information with an ID code included in regional information already stored in a storage unit. Further, the data screening unit stores in the storage unit, among all regional information received by the receiving unit, such regional information that does not correspond to the ID code included in the regional information corresponding to the screening signal and already stored in the storage unit.

### FIELD OF THE INVENTION

The present invention relates to a broadcast information receiving apparatus and a broadcast information receiving and reproducing apparatus that receive and store information broadcast from a broadcast station.

### BACKGROUND OF THE INVENTION

An information providing system that provides information to in-vehicle information terminal apparatus has been proposed in Japanese Patent Laid-Open No. 11-30524, for example. In that system, a broadcast station regularly broadcasts information such as information about certain facilities and events held in a particular region along with positional data (coordinates) indicating the locations of the facilities and event places, and an in-vehicle information terminal apparatus receives all broadcast information and stores the information in a storage medium or update information in the storage medium. When a user of such an in-vehicle information terminal apparatus sets a destination, the in-vehicle information terminal apparatus searches its storage medium for positional data indicating the coordinates of locations within the area of the destination and reads and presents the information relating to the positional data found.

The conventional in-vehicle information terminal apparatus stores all information broadcast from a broadcast station in a storage medium or updates information stored in the storage medium with the information, as described above. Accordingly, the storage medium included in the in-vehicle information terminal apparatus stores information unnecessary for the user such as information about areas outside the area of the destination as well. Thus, in the conventional in-vehicle terminal apparatus, information useless to the user is stored in the recording medium having fixed storage capacity.

Another example of conventional information providing systems that provide information to in-vehicle information terminal apparatus is the one proposed in Japanese Patent Laid-Open No. 2001-244874. In that system, an in-vehicle information terminal apparatus transmits a signal requesting particular information and the particular information is delivered in response to the request.

In the conventional information providing system, the in-vehicle information terminal apparatus must include a two-way communication facility, which adds to costs of the in-vehicle information terminal apparatus.

### DISCLOSURE OF THE INVENTION

An object of the present invention is to provide a broadcast information receiving apparatus and broadcast information receiving and reproducing apparatus that allow a user to set positional data indicating a location about which a user wants information, such as a destination, the current position, and a route to the destination, identify the area of the location such as the destination on the basis of the positional data, select information relating to the identified area from information received from a broadcast station, thereby storing only information useful to the user in a storage medium having a fixed storage capacity, and thus enabling effective use of the recording medium with the fixed storage capacity without needing a two-way communication facility.

To achieve the object, a broadcast information receiving apparatus according to the present invention includes: a receiving unit which receives a broadcast signal from a broadcast station broadcasting regional information relating to a given region divided into predetermined sections beforehand and sends regional information carried by the broadcast signal; a positional data setting unit which sets positional data; a screening data generating unit which identifies a section on the basis of positional data set by the positional data setting unit and generates screening data indicating the section; a storage unit which stores regional information; and a data screening unit which compares section data among various types of attribute data included in regional information sent from the receiving unit with the screening data, compares given attribute data among the various types of attribute data included in the regional information with given attribute data included in regional information already stored in the storage unit, and selects regional information that corresponds to the screening data but does not correspond to given attribute data included in regional information already stored in the storage unit, wherein the regional information selected by the data screening unit is stored in the storage unit.

According to the present invention, only the information that is useful to a user is stored in a storage medium having a fixed storage capacity, therefore the storage space for storing regional information received from the broadcast station can be saved. Consequently, the recording medium with the fixed storage capacity can be effectively used, and yet an inexpensive configuration that does not require a two-way communication facility can be achieved.

In the broadcast information receiving apparatus according to the present invention, the data screening unit compares the content of regional information sent from the receiving unit with the content of regional information already stored in the storage unit, instead of comparing attribute data included in the regional information sent from the receiving unit with attribute data included in the regional information already stored in the storage unit.

The broadcast information receiving according to the present invention further includes a storage control unit which holds beforehand a storage control command representing conditions for making a setting for protecting regional information stored in the storage unit, a setting for overwriting regional information stored in the storage unit, and a setting for deleting regional information stored in the storage unit, which monitors section data or coordinate data included in regional information stored in the storage unit on the basis of positional data set by the positional data setting unit, and which makes any of the settings for protecting, overwriting, and deleting regional information stored in the storage unit in accordance with any of the storage control command.

According to the present invention, protected regional information remains in the storage unit and the data screening unit does not select the same, protected regional information. As a result, the frequency of access from the data screening unit to the storage unit can be reduced and accordingly the efficiency of the system is improved.

In the broadcast information receiving apparatus according to the present invention, a user operation unit allows a user to set a description of any of various types of attribute data included in regional information; the screening data generating unit adds data indicating the description of attributed data specified through the user operation unit to data indicating a section to generate screening data; and the data screening unit compares attribute data having a description specified through the user operation unit in addition to section data included in regional information sent from the receiving unit with the screening data.

According to the present invention, the storage space for storing regional information broadcast from a broadcast station can be further saved. For example, for a section to which a destination belongs, regional information of all information formats, including large-data-volume information such as video information and small-data-volume information such as text information, may be stored, whereas for a section that a set route passes, only regional information of a small-volume information format such as text information may be stored. Thus, the amount of information stored can be minimized. Similarly, for the section to which a destination belongs, information relating to any business categories may be stored whereas for an information acquisition area that a set route passes, only information that relates to restaurants may be stored. Thus, the amount of information stored can be minimized.

Furthermore, in the broadcast information receiving apparatus according to the present invention, the user operation unit can be used to set data about any position, and the screening data generating unit identifies a section on the basis of the data about the position set through the user operation unit and generates screening data indicating the section.

In the broadcast information receiving apparatus according to the present invention, the positional data setting unit detects the current position of the broadcast information receiving apparatus and sets data about the current position; and the screening data generating unit identifies a section on the basis of the data about the current position and generates screening data indicating the section.

Moreover, in the broadcast information receiving apparatus according to the present invention, the positional data setting unit takes a predetermined number of samples of data about the current position and predicts a moving direction of the broadcast information receiving apparatus; and the screening data generating unit predicts and identifies a section to which the broadcast information receiving apparatus moves on the basis of data about the current position and data about the moving direction, and further generates screening data indicating the predicted section.

In the broadcast information receiving apparatus according to the present invention, the positional data setting unit monitors the state of gears of a mobile unit in which the broadcast information receiving apparatus is installed; and determines, on the basis of the state of the gears of the mobile unit, current-position data to be sampled.

According to the present invention, the accuracy of prediction of the moving direction can be improved.

In the broadcast information receiving apparatus according to the present invention, the positional data setting unit adds information format type data which is one type of attribute data to positional data; the screening data generating unit adds data indicating the type of information format as a weight to data indicating a section to generate screening data; and the data screening unit compares section data and information format type data included in regional information sent from the receiving unit with the screening data.

A broadcast information receiving and reproducing apparatus according to the present invention includes a reproduction control unit which reproduces, among pieces of regional information stored in the storage unit, regional information relating to an area within a predetermined distance from the current position or regional information relating to the section to which the current position belongs on the basis of current-position data provided from the positional data setting unit.

### BRIEF DESCRIPTION OF THE DRAWINGS

FIG. 1 shows an exemplary format of a broadcast signal according to an embodiment of the present invention;

FIG. 2 shows a configuration of a broadcast information receiving apparatus according to a first embodiment of the present invention;

FIG. 3 shows a configuration of a broadcast information receiving apparatus according to a second embodiment of the present invention;

FIG. 4 shows a configuration of a broadcast information receiving apparatus according to a third embodiment of the present invention;

FIG. 5 shows a configuration of a broadcast information receiving apparatus according to a fourth embodiment of the present invention;

FIG. 6 shows a configuration of a broadcast information receiving apparatus according to a fifth embodiment of the present invention;

FIG. 7 shows a configuration of a broadcast information receiving apparatus according to a sixth embodiment of the present invention; and

FIG. 8 shows a configuration of a broadcast information receiving and reproducing apparatus according to a seventh embodiment of the present invention.

### DESCRIPTION OF THE EMBODIMENTS

With reference to the accompanying drawings, embodiments of the present invention will be describe with respect to a car navigation system to which the present invention is applied, by way of example.

The car navigation system in the present embodiments includes a broadcast station and a broadcast information receiving apparatus or a broadcast information receiving and reproducing apparatus installed in a motor vehicle (mobile unit).

In the system, the broadcast station broadcasts various kinds of regional information relating to a given region on a regular basis. The regional information is broadcast through the medium of broadcast signals. The given region is divided into predetermined information acquisition areas (predetermined sections) beforehand. The regional information includes data indicating which regional information relates to which information acquisition area.

The broadcast information receiving apparatus or the broadcast information receiving and reproducing apparatus receives broadcast signals, selects regional information relating to a desired information acquisition area from the regional information carried by the broadcast signals, and stores the selected regional information in a storage (storage unit).

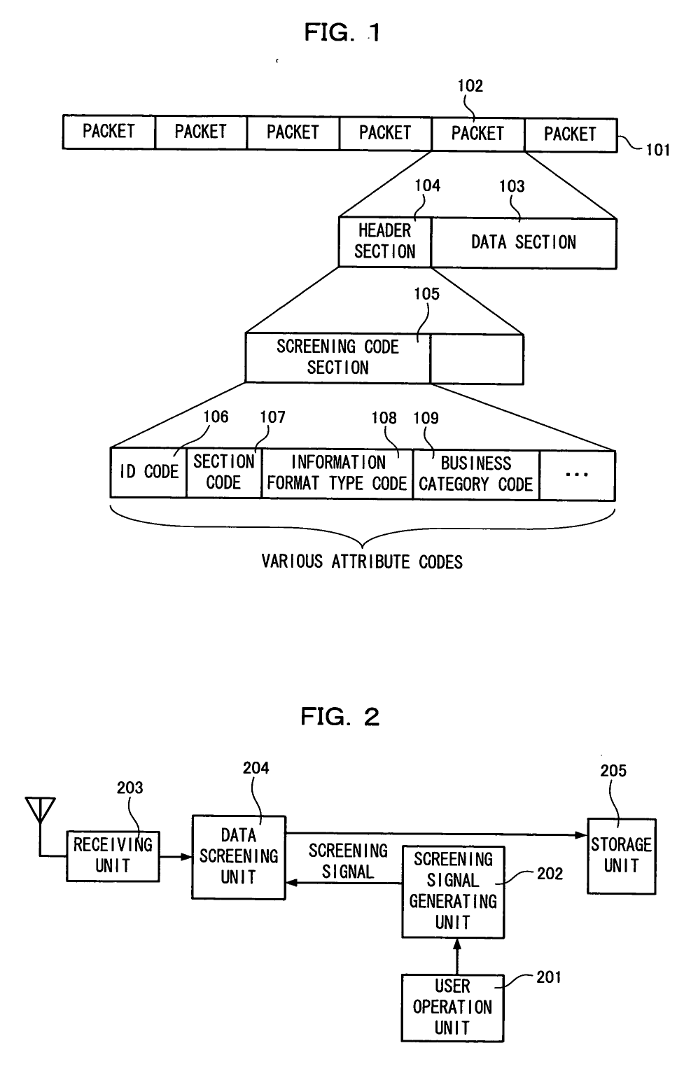

FIG. 1 shows an exemplary format of a broadcast signal in the present embodiments. An example will be described herein in which a broadcast signal consists of packets as shown in FIG. 1.

Each of the packets 102 that make up the broadcast signal 101 consists of a data section 103 and a header section 104. The data section 103 contains the body (content) of the regional information. A portion of the header section 104 represents a screening code section 105. If one piece of regional information is transmitted in multiple packets, the header section 104 contains information indicating the association with the other packets.

The screening code section 105 contains various attribute codes (attribute data) of the regional information. The broadcast information receiving apparatus or broadcast information receiving and reproducing apparatus uses the attribute codes contained in the screening code section 105 to select regional information. The more the types of attribute codes contained in the screening code section 105, the more specific selection the broadcast information receiving apparatus or broadcast information receiving and reproducing apparatus can make.

A specific example of the various attribute codes stored in the screening code section 105 will be described below.

The ID code (identifier) 106 in FIG. 1 is a code for identifying each piece of regional information broadcast from the broadcast station. The section code (section data) 107 is a code for determining which information acquisition area the regional information relates to. The information format type code (information format type data) 108 is a code for identifying the type of information format of the regional information (for example, text information, audio information, or video information). The business category code (business category data) 109 is a code for identifying the business category (for example, accommodation facilities, commercial facilities, amusement facilities or restaurants) to which the regional information belongs.

Other codes may be contained in the screening code section 105, such as an update frequency code (update frequency data) indicating the frequency of update of each piece of regional information broadcast from the broadcast station (for example yearly, monthly, weekly, or daily update, or on an as-needed-basis update).

If regional information is information about an accommodation facility, the information may be linked with map data and a coordinate code (coordinate data) used for presenting the position of the accommodation facility on a map displayed on a screen may be contained in the header section 104.

The region covered by a broadcast station can be divided into information acquisition areas (predetermined sections) in many ways. For example, the region may be divided into areas on the basis of postal codes, telephone numbers, or may be divided in accordance with administrative districts (such as states, prefectures, cities, towns, villages, or wards), or may be divided by splitting a map of the region into squares and assigning serial numbers to the squares.

First embodiment

A broadcast information receiving apparatus according to a first embodiment of the present invention will be described below. FIG.2 shows a configuration of a broadcast information receiving apparatus according to the first embodiment. The broadcast information receiving apparatus is installed in a motor vehicle (mobile unit).

A user operation unit 201 in FIG. 2, which is a positional data setting unit, is an input device through which a user can set data indicating any location. Positional data set through the user operation unit 201 is used for selecting regional information relating to the information acquisition area (section) to which that location belongs from among pieces of regional information broadcast from a broadcast station, which is not shown.

In particular, the user operation unit 201 allows a user to set a destination, a route, or a spot or range the user wants to check out. These settings may be specified on a map displayed on a screen, not shown. An information acquisition area may be specified to set a range to check out.

If a destination or a spot to check out is set, the user operation unit 201 sends data indicating the position of the destination or the spot; if a route is set, the user operation unit 201 sends data indicating predetermined locations on the route; if a range to check out is set, the user operation unit 201 sends data indicating predetermined locations within the range. If a range to check out is set based on an information acquisition area, the user operation unit 201 sends the area's section code.

The user can also specify any attribute code among various attribute codes (attribute data) included in regional information and a description of the attribute code through the user operation unit 201. In particular, the user can specify a description such as the type of information format of regional information or a business category by using the user operation unit 201. A description of attribute data can be specified for each of a destination, a route, and a spot and range to check out.

A screening signal generating unit 202, which is a screening data generating unit, identifies, on the basis of data about a location sent from the user operation unit 201, an information acquisition area to which the location belongs, and generates and outputs a screening signal (screening data) indicating the information acquisition area. The screening signal in this example is a signal indicating a section code.

In particular, if a destination is specified, the screening signal generating unit 202 identifies the information acquisition area to which the destination belongs and generates a screening signal indicating the information acquisition area. If a route is specified, the screening signal generating unit 202 identifies each of the information acquisition areas to which predetermined positions on the set route belongs and generates a screening signal indicating the information acquisition areas that the set route passes. If a spot to check out is set, the screening signal generating unit 202 identifies the information acquisition area to which the spot belongs and generates a screening signal indicating the information acquisition area. If a range to check out is set, the screening signal generating unit 202 identifies each of the information acquisition area to which predetermined positions within the range belong and generates a screening signal indicating an information acquisition area corresponding to the range to check out.

If a description of an attribute code is set, the screening signal generating unit 202 adds a signal indicating the specified description of the attribute code to a signal indicating an information acquisition area to generate a screening signal (screening data). For example, if descriptions of the type of an information format and a business category are specified, the screening signal generating unit 202 generates a screening signal consisting of a signal indicating an information acquisition area (section code) to which a signal indicating the specified description of the type of information format (type code) and a signal indicating the specified description of the business category are added.

Consequently, for the information acquisition area to which the destination belongs, regional information of all information formats, from large-data-volume information such as video information to small-data-volume information such as text information, for example, may be stored, whereas for the information acquisition area that the set route passes, regional information of only a small-data-volume information format such as text information may be stored. Similarly, for the information acquisition area to which the destination belongs, regional information relating to all business categories may be stored, whereas for the information acquisition area that the set route passes, regional information to be stored can be limited to regional information relating to restaurants, for example.

A receiving unit 203, which is a receiver, receives a broadcast signal from a broadcast station (not shown) and sends regional information carried by the broadcast signal.

A data screening unit 204, which is a data selector, compares attribute codes (such as a section code, type code, and business category code) included in each piece of regional information provided from the receiving unit 203 with screening signals provided from the screening signal generating unit 202. The data screening unit 204 also compares an ID code (predetermined attribution data) included in each piece of regional information with an ID code included in regional information already stored in a storage unit 205. The data screening unit 204 then selects and sends regional information that matches the screening signal but does not match the ID code included in the regional information already stored in the storage unit 205.

The storage unit 205, which is a storage, stores regional information (including attribute codes) sent from the data screening unit 204.

In this way, the broadcast information receiving apparatus stores in the storage unit 205 regional information that does not correspond to the ID code contained in the regional information already stored in the storage unit 205, thus avoiding the same regional information as regional information already stored in the storage unit 205 from being redundantly stored in the storage unit 205.

It should be noted that regional information may be compared with not only the ID code of each piece of regional information already stored in the storage unit 205 but also with other attribute codes.

Furthermore, even regional information that corresponds to an ID code contained in a piece of regional information already stored in the storage unit 205 may be checked to determine whether the content of the regional information (the body of regional information contained in the data section 103) is identical to the piece of the regional information stored in the storage unit and, if different, the piece of regional information stored in the storage unit 205 may be updated with the information.

In the case where update frequency codes are included in regional information, a piece of regional information having an update frequency code, “Update on an as-needed basis”, for example, may be updated even if the piece of regional information corresponds to an ID code included in regional information already stored in the storage unit 205, whereas other pieces of regional information having other frequency codes such as “Update yearly” may not be updated.

Regional information stored in the storage unit 205 may be reproduced in response to a command provided from a user through the user operation unit, for example.

Thus, according to the first embodiment, in an information providing system in which a broadcast station broadcasts unsolicited pieces of regional information, regional information that relates to an information acquisition area (section) for which a user wants regional information and does not overlap any of the regional information stored in a storage unit can be selected and stored in the storage unit from among the unsolicited pieces of regional information.

While the first embodiment has been described with respect to a car navigation system by way of example, the first embodiment can be applied to any apparatus that allows a user to make various settings by using a user operation unit and selects information to receive on the basis of the settings. For example, the first embodiment can be applied to a mobile terminal device as well.

Second embodiment

A broadcast information receiving apparatus according to a second embodiment of the present invention will be described below.

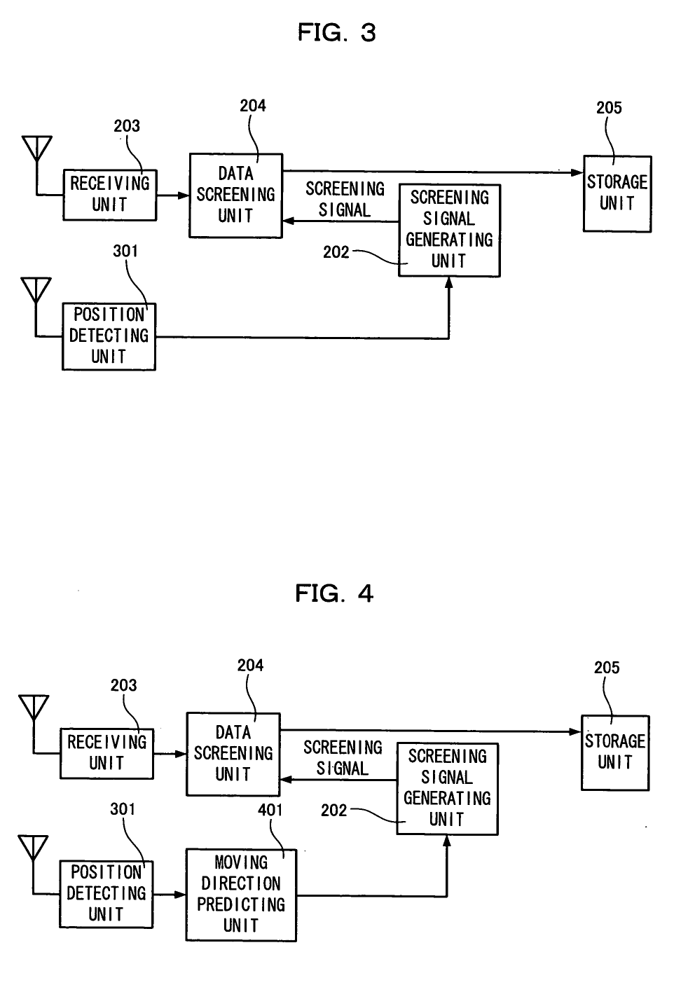

FIG. 3 shows a configuration of a broadcast information receiving apparatus according to the second embodiment. The same elements that have been described with respect to the first embodiment will be labeled with the same reference numerals and detailed description of which will be omitted.

In FIG. 3, a position detecting unit 301, which is a position data setting unit, detects the current position of the broadcast information receiving apparatus, that is, the current position of the vehicle in which the broadcast information receiving apparatus is installed, and sets the data about the current position.

The data about the current position set by the position detecting unit 301 is used for selecting regional information relating to the information acquisition area (section) to which the current position belongs from among pieces of regional information broadcast from a broadcast station, not shown.

A screening signal generating unit 202 identifies, on the basis of data about the current position sent from the position detecting unit 301, the information acquisition area to which the current position belongs, and generates and outputs a screening signal (screening data) indicating that information acquisition on area. The screening signal here is a signal indicating a section code.

In the broadcast information receiving apparatus, the position detecting unit 301 detects the current position, and the screening signal generating unit 202 generates, on the basis of the data about the current position, a screening signal (section code) indicating the information acquisition area to which the current position belongs and provides it to a data screening unit 204. The data screening unit 204 compares a section code (section data) contained in each piece of regional information sent from a receiving unit 203 with the screening signal. The data screening unit 204 also compares an ID code (predetermined attribute data) included in each piece of regional information sent from the receiving unit 203 with an ID code included in regional information already stored in a storage unit 205. The data screening unit 204 then selects and sends regional information that matches the screening signal but does not match the ID code included in the regional information stored in the storage unit 205. The storage unit 205 stores the regional information (including various attribute codes) provided from the data screening unit 204.

It should be noted that regional information stored in the storage unit 205 may be reproduced, for example, in response to a command provided by a user through a user operation unit, not shown. Alternatively, a coordinate code (coordinate data) included in regional information may be used to automatically reproduce regional information that relates to an area within a predetermined distance from the current position.

Thus, according to the second embodiment, in the information providing system in which a broadcast station broadcasts unsolicited pieces of regional information, regional information that relates to the information acquisition area (section) to which the current position belongs but does not overlap regional information already stored in a storage unit can be selected and stored in the storage unit from among the pieces of unsolicited regional information.

While the second embodiment has been described with respect to a case where the information acquisition area to which the current position belongs is identified, regional information relating to an information acquisition area or areas adjacent to that information acquisition area may also be stored. Furthermore, a user operation unit, not shown, may allow a user to set an area about which the user wants regional information.

While the second embodiment has been described with respect to a car navigation system by way of example, the second embodiment can be applied to any apparatus that selects information to receive on the basis of the current position. For example, the second embodiment can be applied to a mobile terminal device as well.

Third embodiment

A broadcast information receiving apparatus according to a third embodiment of the present invention will be described below.

FIG. 4 shows a configuration of a broadcast information receiving apparatus according to the third embodiment. The same elements that have been described with respect to the first and second embodiments will be labeled with the same reference numerals and detailed description of which will be omitted.

In FIG. 4, a moving direction predicting unit 401 included in a position data setting unit takes a predetermined number of samples of data about the current position provided from a position detecting unit 301 and predicts the moving direction of the broadcast information receiving apparatus.

A screening signal generating unit 202 receives data about the current position sent from the position detecting unit 301 through the moving direction predicting unit 401 and identifies the information acquisition area (section) to which the current position belongs on the basis of that information. The screening signal generating unit 202 predicts and identifies an information acquisition area (section) to which the broadcast information receiving apparatus (motor vehicle) will travel, on the basis of the data about the current position and the data about the moving direction sent from the moving direction predicting unit 401. The screening signal generating unit 202 then generates and outputs screening signals (screening data) indicating the information acquisition area (section) to which the current position belongs and the predicted information acquisition area (section) to which the broadcast information receiving apparatus will travel.

In the broadcast information receiving apparatus, the position detecting unit 301 detects the current position and the moving direction predicting unit 401 predicts the moving direction. Then, the screening signal generating unit 202 generates a screening signal (section code) indicating the information acquisition area to which the current position belongs and a screening signal (section code) indicating the predicted information acquisition area to which the broadcast information receiving apparatus will travel, on the basis of the data about the current position and the data about the moving direction, and provides the screening signals to a data screening unit 204. The data screening unit 204 compares a section code included in each piece of regional information sent from a receiving unit 203 with the screening signals. The data screening unit 204 compares an ID code included in each piece of regional information sent from the receiving unit 203 with an ID code included in regional informational ready stored in a storage unit 205. The data screening section 204 then selects regional information that matches the screening signals but does not match the ID code included in the regional informational ready stored in the storage unit 205. The storage unit 205 stores the regional information (including various attribute codes) provided from the data screening unit 204.

Thus, according to the third embodiment of the present invention, in an information providing system in which a broadcast station broadcasts unsolicited pieces of regional information, regional information can be selected and stored that relates to the information acquisition area (section) to which the current position of a broadcast information receiving apparatus belongs and the predicted information acquisition area (section) to which the broadcast information receiving apparatus will travel but does not overlap regional information stored in the storage unit, from among the pieces of unsolicited regional information.

If regional information relating to an information acquisition area adjacent to the information acquisition area to which the current position belongs is also to be stored, regional information relating to an information acquisition area ahead of the adjacent information acquisition area may be stored for the regional information relating to the predicted information acquisition area to which the broadcast information receiving apparatus will travel.

While the third embodiment has been described with respect to a car navigation system by way of example, the third embodiment can be applied to any apparatus that select information to receive on the basis of its current position and moving direction. For example, the third embodiment can be applied to a mobile terminal device as well.

Fourth embodiment

A broadcast information receiving apparatus according to a fourth embodiment of the present invention will be described below.

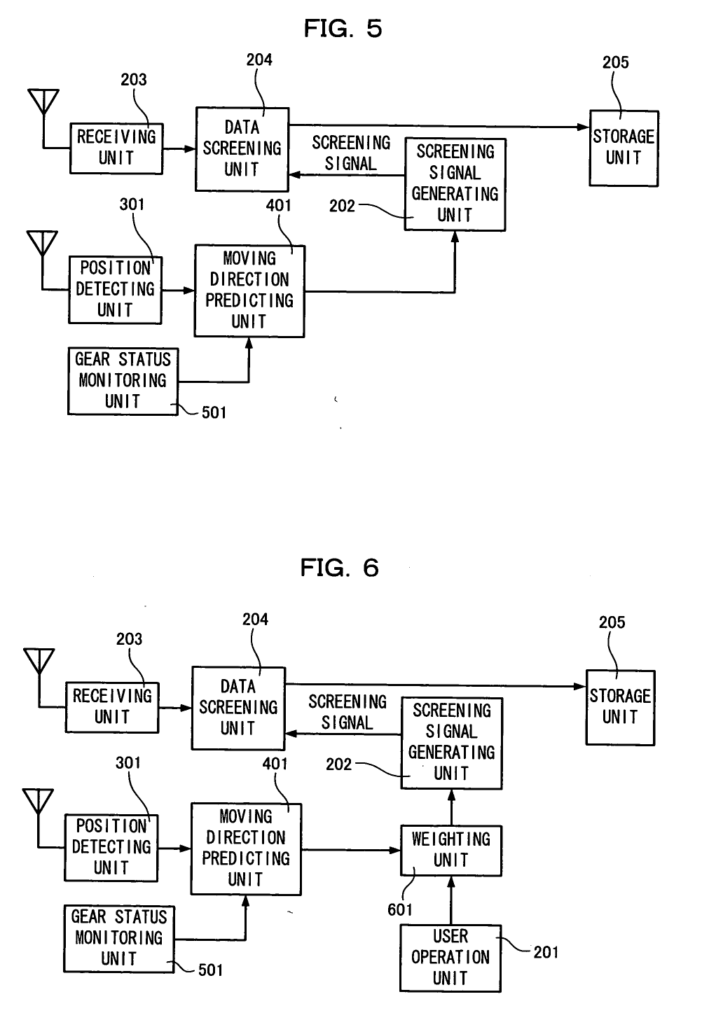

FIG. 5 shows a configuration of a broadcast information receiving apparatus according to the fourth embodiment. The same element that have described with respect to the first to third embodiments will be labeled with the same reference numerals and detailed description of which will be omitted.

In FIG. 5, a gear status monitoring unit 501 included in a position data setting unit monitors the status of the gears of a motor vehicle in which the broadcast information receiving apparatus is installed. A moving direction predicting unit 401 determines, on the basis of data about the state of gears, current-position data to sample, takes a predetermined number of samples of the determined current-position data, and predicts the moving direction.

In particular, if it determines on the basis of the gear state that the motor vehicle is being reversed, the moving direction predicting unit 401 excludes data about current positions detected during the reversing and restarts sampling at the time point at which the vehicle makes a forward move.

Fifth embodiment

A broadcast information receiving apparatus according to a fifth embodiment of the present invention will be described below.

FIG. 6 shows a configuration of a broadcast information receiving apparatus according to the fifth embodiment. The same elements that have been described with respect to the first to fourth embodiments will be labeled with the same reference numerals and detailed description of which will be omitted.

In FIG. 6, a weighting unit 601 included in a positional data setting unit adds a information format type code (information format type data) to each of pieces of data for identifying an information acquisition area (section) sent from a user operation unit 201, a position detecting unit 301, and a moving direction predicting unit 401. A weight is assigned to each items of positional data such as a destination and a route, provided from the user operation unit 201. The weighting herein means limiting the type of information format. The information format type to be added as a weight may be set arbitrarily by a user at the user's choice through the user operation unit 201 or may be held by the weighting unit 601 as initial data.

The screening signal generating unit 202 identifies an information acquisition area as described with respect to the first to fourth embodiments, and adds a signal indicating an information format type added by the weighting unit 601 to the signal indicating the information acquisition area to generate a screening signal (screening data).

However, if a user specifies an information format type through use of the user operation unit 201 for positional data set through the user operation unit 201 as described with respect to the first embodiment, the weighting unit 601 gives priority to the type specified through the user operation unit 201 over the weight assigned by the weighting unit 601.

Furthermore, the user may be allowed to specify any of various attribute codes and a description of the attribute code for current-position data provided from the position detecting unit 301 and moving-direction data provided from the moving direction predicting unit 401 by using the user operation unit 201. If the user specifies a information format type through the user operation unit 201 for the current-position data from the position detecting unit 301 and the moving-direction data from the moving direction predicting unit 401, the weighting unit 601 gives priority to the type specified through the user operation unit 201 over the weight assigned by the weighting unit 601.

A specific exemplary method for weighting by the weighting unit 601 will be given below.

For example, for an information acquisition area that a set route passes, regional information of only a small-volume information format such as text information may be stored. For a predicted information acquisition area to which the vehicle will travel, regional information of all information formats, including a large-data-volume information such as video information and small-data-volume information such as text information, may be stored. Furthermore, for the information acquisition area to which the current position belongs, regional information of all information formats, from a large-data-volume information such as video information to small-data-volume information such as text information, may be stored, whereas for a predicted information acquisition area to which the vehicle will travel, regional information of only a small-volume information format such as text information may be stored.

Thus, according to the fifth embodiment of the present invention, an information format type of regional information to be selected can be determined.

For the sake of system efficiency and power saving, a configuration is desirable in which the user can select any of the regional information screening based on positional data provided from the user operation unit 201, the regional information screening based on current-position data provided from the position detecting unit 301, and the regional information screening based on moving-direction data provided from the moving direction predicting unit 401. The apparatus may prompt the user to select a regional information screening scheme.

Sixth embodiment

A broadcast information receiving apparatus according to a sixth embodiment of the present invention will be described below.

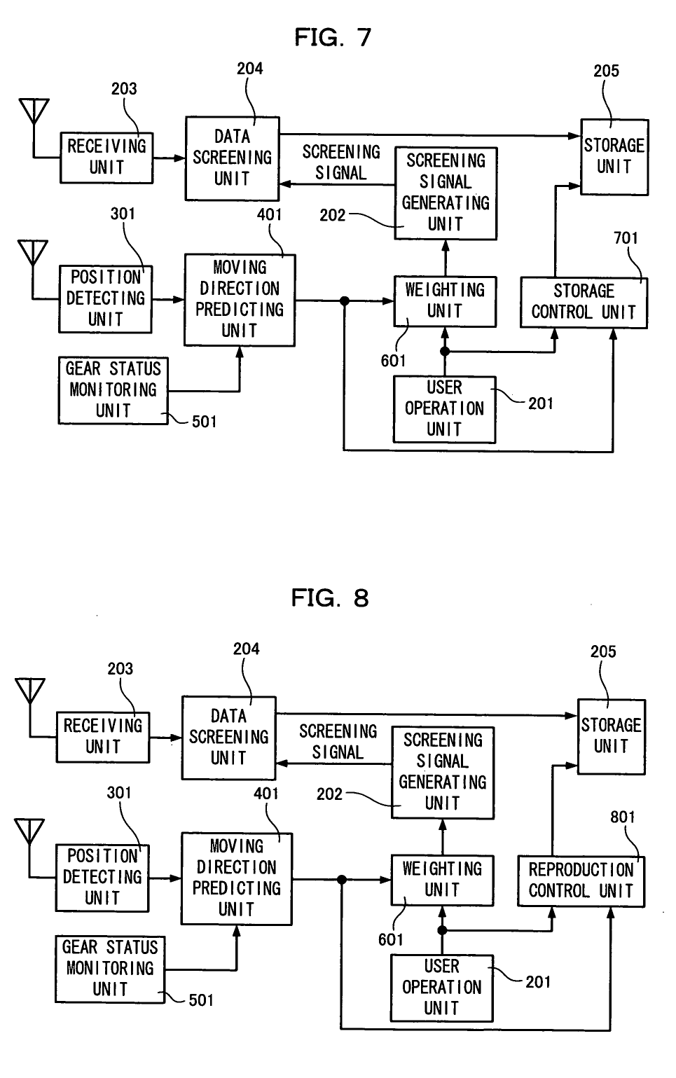

FIG. 7 shows a configuration of a broadcast information receiving apparatus according to the sixth embodiment. The same elements that have been described with respect to the first to fifth embodiments will be labeled with the same reference numerals and detailed description of which will be omitted.

In FIG. 7, a storage control unit 701, which is a storage controller, monitors section codes (section data) and coordinate codes (coordinate data) included in regional information stored in a storage unit 205 on the basis of positional data provided from a user operation unit 201 and current-position data provided from a position detecting unit 301, and makes a setting for protecting, overwriting, or deleting regional information stored in the storage unit 201 according to a storage management information held in the storage control unit 701. The storage control information may be set by a user at the user's choice through the user operation unit 201, or may be held in the storage control unit 701 as initial data.

For example, if the storage control information is to protect regional information relating to an area within a predetermined distance from a destination or regional information relating to the information acquisition area (section) to which a destination belongs, and to delete or overwrite regional information other than the protected regional information after the current position enters the area within the predetermined distance from the destination or the information acquisition area to which the destination belongs, the storage control unit 701 operates as follows. The storage control unit 701 monitors coordinate codes and section codes included in the regional information stored in the storage unit 205 on the basis of data about the destination provided from the user operation unit 201 and makes a setting for protecting the regional information relating to the area within the distance from the predetermined distance from the destination or the information acquisition area to which the destination belongs. When the storage control unit 701 determines on the basis of data about the current position provided from the position detecting unit 301 that the current position has entered the area within the predetermined distance from the destination or to the information acquisition area to which the destination belongs, the storage control unit 701 makes a setting for delete or overwrite regional information other than the protected regional information.

If the storage control information is to protect regional information relating to an area within a predetermined distance from a route set through the user operation unit 201 or regional information relating to an information acquisition area that the set route passes, the storage control unit 701 operates as follows. The storage control unit 701 monitors coordinate codes and section codes included in the regional information stored in the storage unit 205 on the basis of data about the set route provided from the user operation unit 201, and makes a setting for protecting regional information relating to the area within the predetermined distance from the set route or to the information acquisition area that the set route passes. The setting for protecting regional information relating to a set route in this way eliminates the need for reacquiring the regional information when the user returns to the departure point through the same route after arriving the destination.

If the storage control information is to delete or overwrite regional information relating to an area within a predetermined distance from a route set through the user operation unit 201 or regional information relating to an information acquisition area which the set route passes on condition that the motor vehicle equipped with the broadcast information receiving apparatus passed the area, the storage control unit 701 operates as follows. The storage control unit 701 monitors coordinate codes and section codes included in the regional information stored in the storage unit 205 on the basis of data about the set route (data about predetermined positions on the set route) provided from the user operation unit 201. Then, each time the storage control unit 701 determines on the basis of data about the current position provided from the position detecting unit 301 that the motor vehicle has passed an area within a predetermined distance from each of the predetermined positions on the set route or that the motor vehicle has passed each information acquisition area that the set route passes, the storage control unit 701 makes a setting for deleting or overwriting regional information relating to the passed area or the information acquisition area that the vehicle has passed.

If the storage control information is to protect regional information relating to an area within a predetermine distance from a route that the vehicle has actually traveled or regional information relating to an information acquisition area that the vehicle passed in the past, the storage control unit 701 operates as follows. The storage control unit 701 records a history of a route that the vehicle has actually traveled on the basis of current-position data from the position detecting unit 301. The storage control unit 701 monitors coordinate codes or section codes included in regional information stored in the storage unit 205 on the basis of the history data, and makes a setting for protecting regional information relating to an area within the predetermined distance from the recorded traveled route or regional information relating to information acquisition areas that the recorded traveled route has passed. Making the setting for protecting regional information relating to the route that the vehicle has actually traveled in this way eliminates the need for reacquiring the regional information when the user returns to the departure point through the same route after arriving the destination.

If the storage control information is to delete or overwrite regional information relating to an area within a predetermined distance from a route that the vehicle has actual traveled or regional information relating to an information acquisition area that the vehicle passed in the passed, the storage control unit 701 operates as follows. The storage control unit 701 records a route that the motor vehicle has actually traveled on the basis of current-position data provided from the position detecting unit 301. The storage control unit 701 monitors coordinate codes or section codes included in regional information stored in the storage unit 205 on the basis of the history data and makes a setting for deleting or overwriting regional information relating to an area within the predetermined distance from the recorded traveled route or regional information relating to an information acquisition area that the recorded traveled route has passed.

If the storage control information is to protect regional information that is updated at lower frequencies, the storage control unit 701 monitors update frequency codes included in regional information stored in the storage unit 205 and makes a setting for protecting regional information that is updated at a lower frequency, for example, “weekly”.

The storage control unit 701 may send an ID code of regional information for which it has made a setting for protection to a data screening unit 204, which then may avoid selecting the regional information corresponding to the ID code, thus screening out the protected regional information at the data selecting unit 204.

Furthermore, if a storage unit 205 is shared with another apparatus, making a setting for protection keeps the protected regional information from being deleted, unless the setting is removed. Thus the need for reacquiring the regional information is eliminated.

Seventh embodiment

A broadcast information receiving and reproducing apparatus according to a seventh embodiment of the present invention will be described below.

FIG. 8 shows a configuration of a broadcast information receiving and reproducing apparatus according to the seventh embodiment. The same elements that have been described with respect to the first to fifth embodiments will be labeled with the same reference numerals and detailed description of which will be omitted. The broadcast information receiving and reproducing apparatus includes a reproduction control unit 801 as a reproduction control unit that controls reproduction of regional information stored in a storage unit 205.

The reproduction control unit 801 monitors section codes or coordinate cords included in regional information stored in the storage unit 205 on the basis of current-position data from a position detecting unit 301, and automatically reproduce regional information relating to the information acquisition area (section) to which the current position belongs or regional information relating to an area within a predetermined distance from the current position, for example. The broadcast information receiving and reproducing apparatus also has the function of reproducing broadcast information in accordance with an instruction from the user operation unit 201, of course.

While the fifth to seventh embodiments have been described with respect to a car navigation system by way of example, the embodiments can be applied to any apparatus that selects information to receive on the basis of various settings made by a user, or on the current position or moving direction. For example, these embodiments can be applied to a mobile terminal device as well.

As has been described, a broadcast information receiving apparatus and a broadcast information receiving and reproducing apparatus according to any of the first to seventh embodiments select and store only information useful to a user from among pieces of received information.

What is claimed is:

1. A broadcast information receiving apparatus comprising:
a receiving unit which receives a broadcast signal from a broadcast station broadcasting regional information relating to a given region divided into predetermined sections beforehand and sends regional information carried by the broadcast signal;
a positional data setting unit which sets positional data;
a screening data generating unit which identifies a section on the basis of positional data set by the positional data setting unit and generates screening data indicating the section;
a storage unit which stores regional information; and
a data screening unit which compares section data among various types of attribute data included in regional information sent from the receiving unit with the screening data, compares given attribute data among the various types of attribute data included in the regional information with given attribute data included in regional information already stored in the storage unit, and selects regional information that corresponds to the screening data but does not correspond to given attribute data included in regional information already stored in the storage unit,
wherein the regional information selected by the data screening unit is stored in the storage unit.

2. The broadcast information receiving apparatus according to claim 1, wherein the data screening unit compares the content of regional information sent from the receiving unit with the content of regional information already stored in the storage unit, instead of comparing attribute data included in the regional information sent from the receiving unit with attribute data included in the regional information already stored in the storage unit, and selects regional information that corresponds to the screening data but has a content different from the content of the regional information already stored in the storage unit.

3. The broadcast information receiving apparatus according to claim 1, further comprising a storage control unit which holds beforehand storage control command representing conditions for making a setting for protecting regional information stored in the storage unit, a setting for overwriting regional information stored in the storage unit, and a setting for deleting regional information stored in the storage unit, which monitors section data or coordinate data included in regional information stored in the storage unit on the basis of positional data set by the positional data setting unit, and which makes any of the settings for protecting, overwriting, and deleting regional information stored in the storage unit in accordance with any of the storage control command.

4. The broadcast information receiving apparatus according to claim 1, wherein:
the positional data setting unit comprises a user operation unit for specifying a description of any of various types of attribute data included in regional information;
the screening data generating unit adds data indicating the description of attributed data specified through the user operation unit to data indicating a section, to generate screening data; and
the data screening unit compares, with the screening data, attribute data having a description specified through the user operation unit in addition to section data included in regional information sent from the receiving unit.

5. The broadcast information receiving apparatus according to claim 1, wherein:
the positional data setting unit comprises a user operation unit through which a user can set data about any position; and
the screening data generating unit identifies a section on the basis of the data about the position set through the user operation unit and generates screening data indicating the section.

6. The broadcast information receiving apparatus according to claim 1, wherein:
the positional data setting unit comprises a position detecting unit which detects the current position of the broadcast information receiving apparatus and sets data about the current position; and
the screening data generating unit identifies a section on the basis of the data about the current position set by the position detecting unit and generates screening data indicating the section.

7. The broadcast information receiving apparatus according to claim 6, wherein:
the positional data setting unit further comprises a moving direction predicting unit which takes a predetermined number of samples of data about the current position provided from the position detecting unit and predicts a moving direction of the broadcast information receiving apparatus; and
the screening data generating unit predicts and identifies a section to which the broadcast information receiving apparatus moves on the basis of data about the current position set by the position detecting unit and data about the moving direction predicted by the moving direction predicting unit, and further generates screening data indicating the predicted section.

8. The broadcast information receiving apparatus according to claim 7, wherein:
the positional data setting unit further comprises a gear status monitoring unit which monitors the state of gears of a mobile unit in which the broadcast information receiving apparatus is installed; and
the moving direction predicting unit determines, on the basis of the state of the gears of the mobile unit, current-position data to be sampled, and samples the determined current-position data.

9. The broadcast information receiving apparatus according to claim 1, wherein:
the positional data setting unit further comprises a weighting unit which adds information format type data which is one type of attribute data to positional data;
the screening data generating unit adds data indicating the type of information format that is added by the weighting unit to data indicating a section to generate screening data; and
the data screening unit compares section data and information format type data included in regional information sent from the receiving unit with the screening data.

10. A broadcast information receiving and reproducing apparatus including the broadcast information receiving apparatus according to claim 6, comprising a reproduction control unit which reproduces, among pieces of regional information stored in the storage unit, regional information relating to an area within a predetermined distance from the current position or regional information relating to the section to which the current position belongs on the basis of current-position data provided from the position detecting unit.
